(19) United States
(12) Patent Application Publication
(10) Pub. No.: US 2022/0147905 A1
(43) Pub. Date: May 12, 2022

(54) SYSTEM AND METHOD FOR ASSISTING FLIGHT CREW WITH THE EXECUTION OF CLEARANCE MESSAGES

(71) Applicant: HONEYWELL INTERNATIONAL INC., Charlotte, NC (US)

(72) Inventors: Gobinathan Baladhandapani, Madurai (IN); Sivakumar Kanagarajan, Bangalore (IN); Hariharan Saptharishi, Bangalore (IN); Thomas Judd, Woodinville, WA (US); Kiran Krishna, Bangalore (IN)

(73) Assignee: HONEYWELL INTERNATIONAL INC., Charlotte, NC (US)

(21) Appl. No.: 17/096,337

(22) Filed: Nov. 12, 2020

(51) Int. Cl. G06Q 10/06; G06N 20/00; G06F 40/253; G06F 40/30

(52) U.S. Cl. CPC G06Q 10/063114; G06F 40/30; G06F 40/253; G06N 20/00

(57) ABSTRACT

A flight deck system for converting a clearance message into sub-tasks for flight crew to execute is provided. The flight deck system comprises a controller configured to: receive the intent of instructions in a clearance message; determine a set of flight-crew executable instructions for performance to meet the intent of the instructions in the clearance message; group the set of instructions as a list of tasks; retrieve aircraft state information from one or more onboard avionics systems; determine context sensitive elements related to the set of instructions in the list of tasks using the retrieved aircraft state information; add the context sensitive elements to the list of tasks; and cause the list of tasks, which includes the set of instructions and the context sensitive elements, to be displayed for flight crew viewing on a display device.

### CROSS REFERENCE TO RELATED APPLICATION

This application claims priority to Indian Provisional Patent Application No. 202011003275, filed Jan. 24, 2020, the entire content of which is incorporated by reference herein.

### TECHNICAL FIELD

Embodiments of the subject matter described herein relate generally to computer-implemented flight aids. More particularly, embodiments of the subject matter relate to computer-implemented flight aids for assisting a flight crew with clearance messages.

### BACKGROUND

When a flight crew receives a clearance via either datalink or voice, the flight crew must perform multiple actions, many of which must be performed at different times. The time chosen to perform many of the steps can be based on a pilot's judgement, a checklist, and/or standard operating procedures. A pilot may have to exercise his memory to execute clearance tasks at the right time, which increases the cognitive workload of the pilot. Moreover, situational awareness and contextual awareness can play a key role in a pilot's decision-making processes. Currently CPDLC is not supplemented with contextual information.

Hence, it is desirable to provide a system that can reduce the workload of a flight crew when a clearance message is received by identifying tasks associated with the clearance message, providing contextual information related to the tasks, and/or alerting the flight crew as to when the tasks should be performed. Furthermore, other desirable features and characteristics of the present invention will become apparent from the subsequent detailed description and the appended claims, taken in conjunction with the accompanying drawings and the foregoing technical field and background.

### SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A flight deck system for converting a clearance message into sub-tasks for flight crew to execute is provided. The flight deck system includes a controller configured to: receive the intent of instructions in a clearance message; determine a set of flight-crew executable instructions for performance to meet the intent of the instructions in the clearance message; group the set of instructions as a list of tasks; retrieve aircraft state information from one or more onboard avionics systems; determine context sensitive elements related to the set of instructions in the list of tasks using the retrieved aircraft state information; add the context sensitive elements to the list of tasks; and cause the list of tasks, which includes the set of instructions and the context sensitive elements, to be displayed for flight crew viewing on a display device.

A method in a flight deck system for converting a clearance message into sub-tasks for flight crew to execute is provided. The method includes receiving the intent of instructions in a clearance message; determining a set of flight-crew executable instructions for performance to meet the intent of the instructions in the clearance message; grouping the set of instructions as a list of tasks; retrieving aircraft state information from one or more onboard avionics systems; determining context sensitive elements related to the tasks using the retrieved aircraft state information; adding the context sensitive elements to the list of tasks; and causing the list of tasks along with the context sensitive elements to be displayed to the flight crew on a display device.

Furthermore, other desirable features and characteristics will become apparent from the subsequent detailed description and the appended claims, taken in conjunction with the accompanying drawings and the preceding background.

### BRIEF DESCRIPTION OF THE DRAWINGS

Embodiments of the subject matter will hereinafter be described in conjunction with the following drawing figures, wherein like numerals denote like elements, and wherein:

FIG. 1A is a diagram depicting an example display screen displayed on a flight deck display device, in accordance with some embodiments;

FIG. 1B is a system block diagram depicting an example flight deck system in an aircraft for facilitating the display of a clearance advisory window on a flight deck display device, in accordance with some embodiments;

FIG. 2A is a process flow chart depicting an example process in an example task list generator and monitor for generating a set of flight-crew executable instructions for performance to meet the intent of the instructions in a clearance message, in accordance with some embodiments;

FIG. 2B is a block diagram depicting an example learning module that can be used to generate a task model for providing a set of flight-crew executable instructions for performance to meet the intent of the instructions in a clearance message, in accordance with some embodiments;

FIG. 3 is a process flow chart depicting an example process for generating a set of flight-crew executable instructions for performance to meet the intent of the instructions in a clearance message, in accordance with some embodiments; and

FIG. 4 is a process flow chart depicting an example process in a flight deck system for converting a clearance message into sub-tasks for flight crew to execute, in accordance with some embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques, and articles for converting a clearance message into sub-tasks for a flight crew to execute. The apparatus, systems, techniques and articles provided herein can result in cognitive work load reduction for the flight crew, heads down time reduction for the flight crew, facilitate Single Pilot Operations, and/or provide contextual information for a CPDLC based clearance system to facilitate the flight crew in taking quick actions and reducing heads down time.

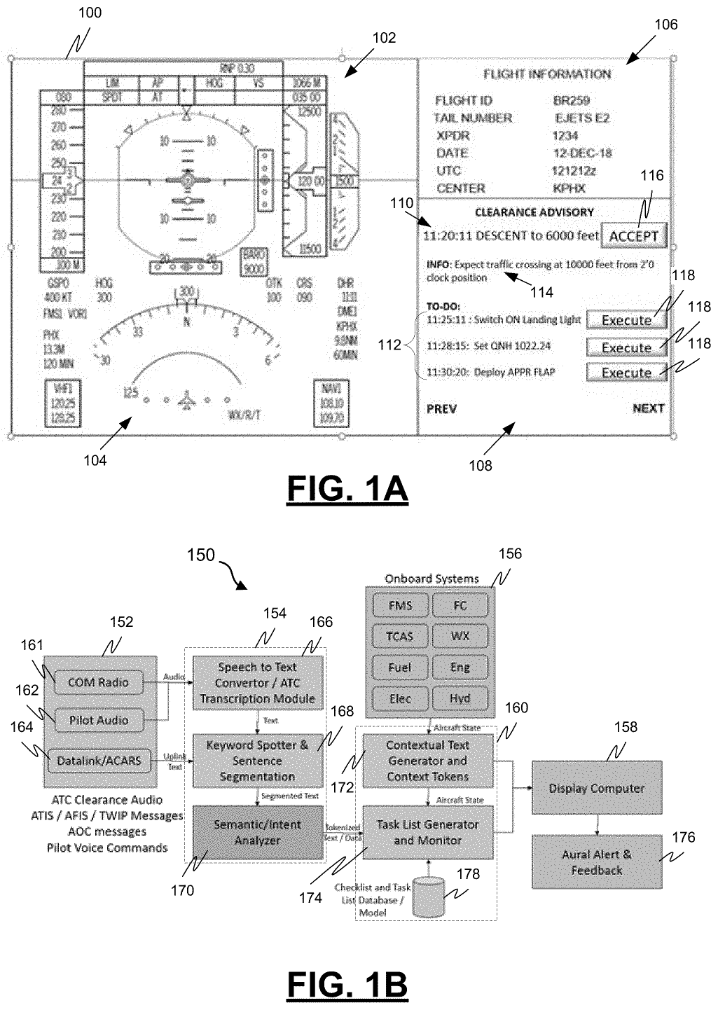

FIG. 1A is a diagram depicting an example display screen 100 displayed on a flight deck display device. The flight deck display device may comprise a primary flight display (PFD), and the example display screen 100 may include both a synthetic vision system (SVS) 102 and a horizontal situation indicator (HSI) 104 for viewing an aircraft flight environment. The example display screen 100 also includes a flight information window 106 and a clearance advisory window 108.

The example clearance advisory window 108 is configured to display a clearance advisory message 110 received from ATC (air traffic control), instructions 112 to be performed to accomplish the intent of the clearance advisory message 110, and one or more context sensitive elements 114. The context sensitive element 114 provides the flight crew with flight environmental context information that may be helpful to know when performing the instructions/tasks necessary to accomplish the intent of the clearance advisory message 110. The example clearance advisory window 108 is also configured to display selectable button widgets that allow the flight crew to accept the clearance advisory message 110 (Accept button 116) and execute the various instructions/tasks (execute buttons 118). The example clearance advisory window 108 is generated by a flight deck system that is configured to convert a clearance advisory message into sub-tasks for flight crew to execute.

The flight deck system comprises a controller. The controller includes at least one processor and a computer-readable storage device or media encoded with programming instructions for configuring the controller. The processor may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the controller.

The controller in the flight deck system is configured to: receive the intent of instructions in a clearance message; determine a set of flight-crew executable instructions for performance to meet the intent of the instructions in the clearance message; group the set of instructions as a list of tasks; retrieve aircraft state information from one or more onboard avionics systems; determine one or more context sensitive elements related to the set of instructions in the list of tasks using the retrieved aircraft state information; add the context sensitive elements to the list of tasks; and cause the list of tasks, which includes the set of instructions and the one or more context sensitive elements, to be displayed for flight crew viewing on a display device.

FIG. 1B is a system block diagram depicting an example flight deck system 150 in an aircraft for facilitating the display of a clearance advisory window on a flight deck display device. The example flight deck system 150 includes communication equipment 152, clearance message pre-processing systems 154, onboard avionics systems 156, a display computer 158, and a display generation system 160 for generating a clearance advisory window to be displayed on a flight deck display device such as the display computer 158.

The example communication equipment 152 includes a COM radio 161, Pilot audio system 162, and datalink/ACARS system 164. The example communication equipment 152 is configured to receive an ATC clearance message, for example, in the form of an ATC audio, ATIS, AFIS, or TWIP message, an AOC message, and Pilot voice commands The example communication equipment 152 is further configured to transmit the received ATC clearance message as audio or text to the clearance message pre-processing system 154.

The example clearance message pre-processing system 154 is configured to preprocess a received clearance message (e.g., CPLDC or voice) to obtain segmented text that identifies the intent of the received clearance message. The example clearance message pre-processing system 154 includes a speech to text converter/ATC transcription module 166 that converts a receive audio message to text, a keyword spotter and sentence segmentation module 168 that is configured to apply parts of speech (POS) tags to the text, and a semantic/intent analyzer 170 that is configured to identify the intent of the instructions in the clearance message from the parts of speech (POS) tags. Each of the example speech to text converter/ATC transcription module 166, the example keyword spotter and sentence segmentation module 168, and the example semantic/intent analyzer 170 are implemented by one or more processors configured by programming instructions on non-transitory computer readable media.

The example onboard avionics systems 156 may include an FMS (flight management system), FC (flight controller), TCAS (traffic collision avoidance system), WX (weather system), Fuel (fuel system), Eng (engine system), Elec (electrical system), Hyd (hydraulic system) and others.

The example display computer 158 may include a flight deck display device such as a PFD, Navigation display (ND), heads up display (HUD), an electronic flight bag (EFB), a tablet computer, or some other device for displaying messages in an aircraft cockpit. The example display computer 158, in addition to providing a flight deck display device, is also configured to provide an aural alert and feedback 178.

The example display generation system 160 comprises a contextual text and context tokens generator 172 and a task list generator and monitor 174. The example contextual text and context tokens generator 172 and example task list generator and monitor 174 are implemented by a controller in the example flight deck system 150.

The task list generator and monitor 174 is configured to receive the intent of instructions in a clearance message, determine a set of flight-crew executable instructions for performance to meet the intent of the instructions in the clearance message, group the set of instructions as a list of tasks, and cause the set of instructions to be displayed for flight crew viewing on a display device such as that provided by the display computer 158. To determine a set of flight-crew executable instructions for performance to meet the intent of the instructions in the clearance message, the task list generator and monitor 174 is configured to retrieve flight-crew executable instructions, from a from a database containing one or more of standard operating procedures (SOPs), checklists, and/or an AFM (aircraft flight manual). To cause the list of tasks to be displayed to the flight crew on a display device, the task list generator and monitor 174 is further configured to combine an event trigger with the task when performance of the task is conditioned on occurrence of an event. To cause the list of tasks to be displayed to the flight crew on a display device, the task list generator and monitor 174 is further configured to provide, when a task is to occur at a predetermined time and the time to execute the task has occurred, a selectable link to be displayed to flight crew that is configurable to cause, when selected, the execution of the task.

The task list generator and monitor 174 is further configured to compare the task list with actual pilot action and record the actual flight crew action, context sensitive elements, and the intent of the instructions in the clearance message. The task list generator and monitor 174 is further configured to train a model to learn to predict pilot action based on the intent of the instructions in the clearance message and the context sensitive elements related to the tasks. To determine a set of flight-crew executable instructions for performance to meet the intent of the instructions in the clearance message, the task list generator and monitor 174 is configured to predict, using the trained model, a set of flight-crew executable instructions based on the intent of the instructions in the clearance message and the context sensitive elements related to the tasks.

The contextual text and context tokens generator 172 is configured to retrieve aircraft state information from one or more onboard avionics systems 156, determine context sensitive elements related to the set of instructions in the list of tasks using the retrieved aircraft state information, add the context sensitive elements to the list of tasks, and cause the context sensitive elements to be displayed for flight crew viewing on a display device such as that provided by the display computer 158. A context sensitive element comprises information regarding an environmental condition that could impact the flight crew's performance of the tasks in the list of tasks. For example, a context sensitive element may include an alert to the flight crew to check surrounding aircraft traffic that may impact clearance instruction before implementing a task.

In operation, the example communication equipment 152 in response to receiving an ATC clearance message transmits an audio message to the speech to text converter/ATC transcription module 166 when the received ATC clearance message is a voice message, or when Pilot audio related to a clearance message is detected. The speech to text converter/ATC transcription module 166 converts the audio message to text and transmits the text to the keyword spotter and sentence segmentation module 168. Alternatively, the example communication equipment transmits a text message direct to the keyword spotter and sentence segmentation module 168 when the received ATC clearance message is in the form of a data message. The keyword spotter and sentence segmentation module 168 generates segmented text from the text received from either the communication equipment 152 or the speech to text converter/ATC transcription module 166 and sends the segmented text (e.g., with parts of Speech (POS) tags which can help in identifying the intent of the instructions) to the semantic/intent analyzer 170. The example semantic/intent analyzer 170 determines the intent of the ATC message and generates tokenized text/data to communicate the intent of the ATC message.

The example semantic/intent analyzer 170 provides to the display generation system 160 tokenized text or data that identifies the intent of the ATC clearance message. The task list generator and monitor 174 of the display generation system 160, based on the received tokenized text or data, retrieves a set of instructions for the flight crew to perform from a checklist and task list database or model 176. A checklist and task list database would contain predetermined sets of instructions that can be retrieved that relate to the tokenized text or data. A checklist and task list model would be a model trained using machine learning techniques that can generate sets of instructions based on the tokenized text or data. The set of instructions are grouped and displayed to the flight crew as tasks.

The example contextual text and context tokens generator 172 retrieves aircraft flight or state information from the onboard avionics systems 156 and determines one or more context sensitive elements to include in the list of tasks based on the tokenized text or data. A context sensitive element comprises information regarding an environmental condition that could impact the flight crew's performance of the tasks in the list of tasks. For example, a context sensitive element may include an alert to the flight crew to check surrounding aircraft traffic that may impact clearance instruction before implementing a task. Context sensitive elements are determined and combined to the list of tasks.

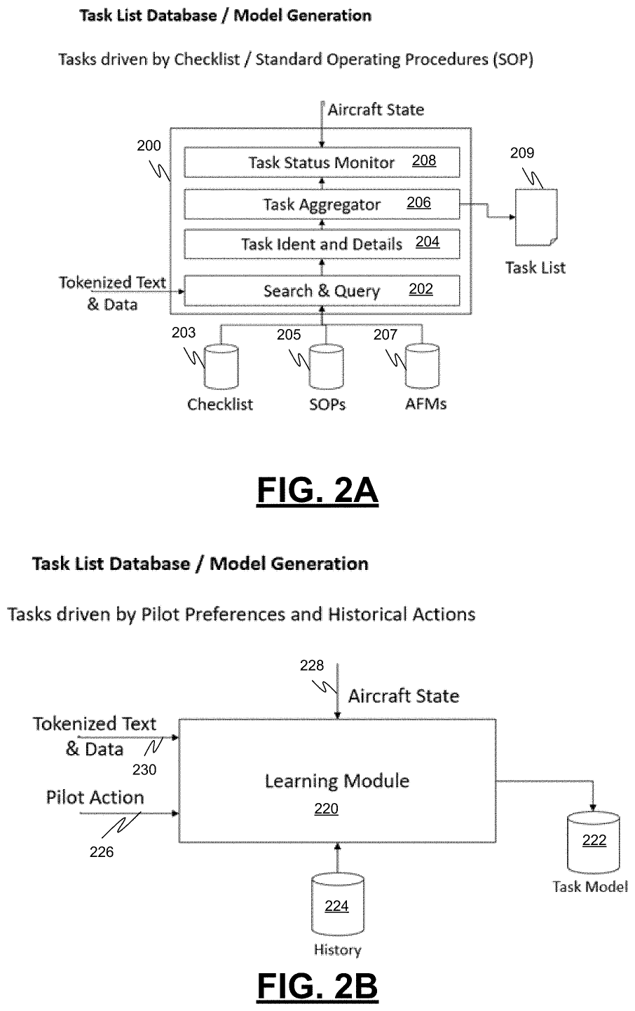

FIG. 2A is a process flow chart depicting an example process 200 in an example task list generator and monitor 174 for generating a list of tasks. The order of operation within the process 200 is not limited to the sequential execution as illustrated in the figure but may be performed in one or more varying orders as applicable and in accordance with the present disclosure.

The example process 200 includes receiving tokenized text and data that identifies the intent of a clearance message at a search and query engine and, based on the tokenized text and data, performing a search and query for information regarding one or more tasks to perform to meet the intent of the clearance message (operation 202). The search and query may result in retrieving information from one or more checklists 203, one or more SOPs 205, and/or one or more AFMs 207. One or more of the checklists 203, SOPs 205, and/or AFMs 207 may be included in a database accessible by the search and query engine. After retrieval of the information, task identification and details are determined from the information (operation 204). A task aggregator 206 can aggregate the various tasks based on the clearance message to which the tasks pertain, for example, if more than one clearance message is received. A task status monitor 208 can retrieve aircraft state information related to the clearance message, identify context sensitive elements from the aircraft state information and provide the context sensitive elements to the task aggregator 206. The task aggregator can generate a task list 209 that includes the list of tasks and the context sensitive elements. The task list 209 can be provided for display to the flight crew.

FIG. 2B is a block diagram depicting an example learning module 220 that can be used to generate a task model 222 for providing a set of flight-crew executable instructions for performance to meet the intent of the instructions in a clearance message. The learning module 220 is configured to compare a historical task list (e.g., from a historical database 224) with actual flight crew action 226, and record the actual flight crew action, context sensitive elements from aircraft state information 228, and the intent of the instructions in the clearance message as evidenced by tokenized text and data 230. The learning module 220 is further configured to train the task model 222 using machine learning techniques to learn to predict flight crew action based on the intent of the instructions in the clearance message and the context sensitive elements related to the tasks. After training, the task model 222 may be used to identify a set of flight-crew executable instructions based on the intent of the instructions in a clearance message and the context sensitive elements related to the tasks.

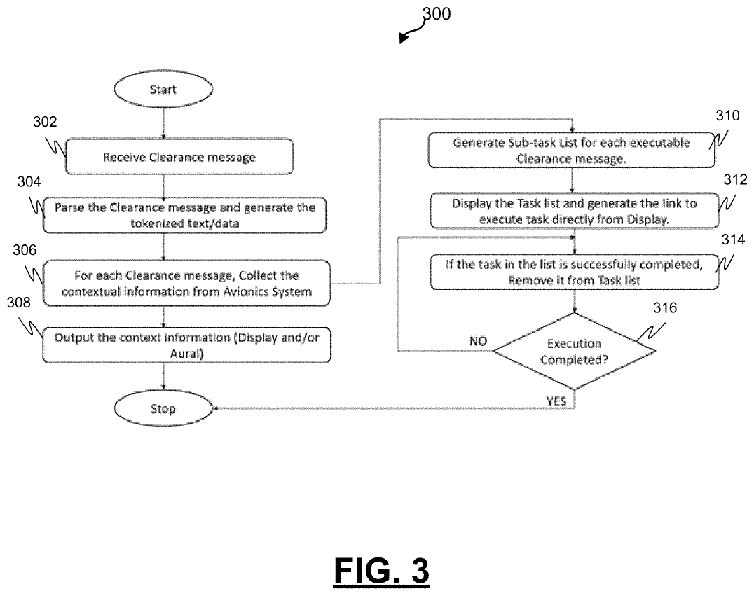

FIG. 3 is a process flow chart depicting an example process 300 for generating a list of tasks. The order of operation within the process 200 is not limited to the sequential execution as illustrated in the figure but may be performed in one or more varying orders as applicable and in accordance with the present disclosure.

The example process 300 includes receiving one or more clearance messages (operation 302), parsing the clearance message and generating tokenized text and data (operation 304), and for each clearance message, collecting contextual information from avionics systems (operation 306). The example process 300 includes outputting the context information as a visual display and/or aural display (operation 308).

The example process 300 includes generating a task list for each executable clearance message (operation 310). The example process 300 also includes displaying the task list and generating a link to execute a task directly from the display (operation 312).

When a task is successfully completed, the task is removed from the task list (operation 314). If execution of all tasks are not completed (no at decision 316), the example process 300 includes continuing the process and removing a task from the task list when a task is successfully completed. If execution of all tasks are completed (yes at decision 316), the example process 300 can end.

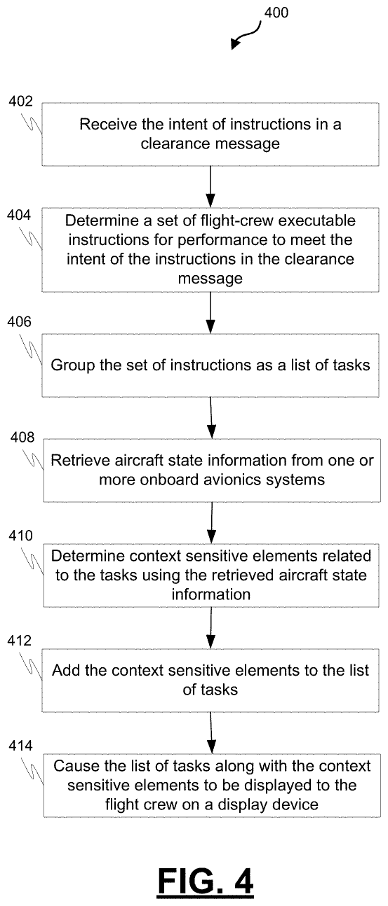

FIG. 4 is a process flow chart depicting an example process 400 in a flight deck system for converting a clearance message into sub-tasks for flight crew to execute. The order of operation within the process 400 is not limited to the sequential execution as illustrated in the figure but may be performed in one or more varying orders as applicable and in accordance with the present disclosure.

The example process 400 includes receiving the intent of instructions in a clearance message (operation 402). Receiving the intent of instructions in a clearance message may comprise preprocessing a received clearance message to obtain segmented text, applying parts of speech (POS) tags to the segmented text, and identifying the intent of the instructions in the clearance message from the parts of speech (POS) tags.

The example process 400 includes determining a set of flight-crew executable instructions for performance to meet the intent of the instructions in the clearance message (operation 404) and grouping the set of instructions as a list of tasks (operation 406). Determining a set of flight-crew executable instructions for performance to meet the intent of the instructions in the clearance message may comprise retrieving instructions from a database containing one or more of standard operating procedures (SOPs), checklists, and/or an AFM (aircraft flight manual). The example process may comprise comparing the task list with actual flight crew action and recording the actual flight crew action, context sensitive elements, and the intent of the instructions in the clearance message; training a model to learn to predict flight crew action based on the intent of the instructions in the clearance message and the context sensitive elements related to the tasks; and predicting, using the trained model, a set of flight-crew executable instructions based on the intent of the instructions in the clearance message and the context sensitive elements related to the tasks.

The example process 400 includes retrieving aircraft state information from one or more onboard avionics systems (operation 408), determining context sensitive elements related to the tasks using the retrieved aircraft state information (operation 410), and adding the context sensitive elements to the list of tasks (operation 412).

The example process 400 includes causing the list of tasks along with the context sensitive elements to be displayed to the flight crew on a display device (operation 414), wherein the flight crew can execute the tasks at an appropriate time. Causing the list of tasks along with the context sensitive elements to be displayed to the flight crew on a display device may comprise combining an event trigger with the task when performance of the task is conditioned on occurrence of an event. Causing the list of tasks along with the context sensitive elements to be displayed to the flight crew on a display device may comprise providing when a task is to occur at a predetermined time and the time to execute the task has occurred, a selectable link to be displayed to flight crew that is configurable to cause, when selected, the execution of the task. Causing the list of tasks along with the context sensitive elements to be displayed to the flight crew on a display device may comprise causing a checklist and an element of interest associated with the checklist item to be displayed to the flight crew when the task is a checklist item to be monitored.

In an example operating scenario, an aircraft's current altitude may be 12000 feet and a clearance message may be a CPDLC Clearance: DESCENT to 6000 feet. Traffic data may be retrieved from ADS-B In or TCAS, which may result in the display of the following context information: “DESCENT to 12000 feet, expect traffic crossing 10000 feet from 2'O clock position.” The context data can be represented graphically or readout or it can be simple text as well.

A task list may be generated which displays:
When crossing below 10000 feet, expected to Switch ON The landing light
If the Transition Layer is 8000 in this airport, the aircraft is expected to change the pressure from QNE to QNH upon crossing 8000 feet.
When reaching 6000 feet, the distance from Runway will be <10 NM so Deploy Approach Flap

Described herein are apparatus, systems, techniques, and articles for converting a clearance message into sub-tasks for flight crew to execute. In one embodiment, a flight deck system for converting a clearance message into sub-tasks for flight crew to execute is provided. The flight deck system comprises a controller configured to: receive the intent of instructions in a clearance message; determine a set of flight-crew executable instructions for performance to meet the intent of the instructions in the clearance message; group the set of instructions as a list of tasks; retrieve aircraft state information from one or more onboard avionics systems; determine context sensitive elements related to the set of instructions in the list of tasks using the retrieved aircraft state information; add the context sensitive elements to the list of tasks; and cause the list of tasks, which includes the set of instructions and the context sensitive elements, to be displayed for flight crew viewing on a display device.

These aspects and other embodiments may include one or more of the following features. To receive the intent of instructions in a clearance message the flight deck system may be configured to: preprocess a received clearance message (e.g., CPLDC or voice) to obtain segmented text; apply parts of speech (POS) tags to the segmented text; and identify the intent of the instructions in the clearance message from the parts of speech (POS) tags. To determine a set of flight-crew executable instructions for performance to meet the intent of the instructions in the clearance message, the controller may be configured to retrieve flight crew executable instructions from: a database containing one or more of standard operating procedures (SOPs), checklists, and/or an AFM (aircraft flight manual); or a task model that has been trained, based on past actions or preferences of the flight crew, to provide a set of flight-crew executable instructions for performance to meet the intent of the instructions in a clearance message. To cause the list of tasks along with the context sensitive elements to be displayed to the flight crew on a display device, the controller may be further configured to combine an event trigger with the task when performance of the task may be conditioned on occurrence of an event. To cause the list of tasks along with the context sensitive elements to be displayed to the flight crew on a display device, the controller may be further configured to provide, when a task is to occur at a predetermined time and the time to execute the task has occurred, a selectable link to be displayed to flight crew that is configurable to cause, when selected, the execution of the task. To cause the list of tasks along with the context sensitive elements to be displayed to the flight crew on a display device, the controller may be further configured to cause to display a checklist and an element of interest associated with the checklist item to the flight crew when the task is a checklist item to be monitored. The controller may be further configured to compare the task list with actual flight crew action and record the actual flight crew action, context sensitive elements, and the intent of the instructions in the clearance message for use in deriving a set of flight-crew executable instructions for a similar, future clearance message. The controller may be further configured to train a model to learn to predict flight crew action based on the intent of the instructions in the clearance message and the context sensitive elements related to the tasks. To determine a set of flight-crew executable instructions for performance to meet the intent of the instructions in the clearance message, the controller may be configured to predict, using the trained model, a set of flight-crew executable instructions based on the intent of the instructions in the clearance message and the context sensitive elements related to the tasks.

In another embodiment, a method in a flight deck system for converting a clearance message into sub-tasks for flight crew to execute is provided. The method comprises receiving the intent of instructions in a clearance message; determining a set of flight-crew executable instructions for performance to meet the intent of the instructions in the clearance message; grouping the set of instructions as a list of tasks; retrieving aircraft state information from one or more onboard avionics systems; determining context sensitive elements related to the tasks using the retrieved aircraft state information; adding the context sensitive elements to the list of tasks; and causing the list of tasks along with the context sensitive elements to be displayed to the flight crew on a display device.

These aspects and other embodiments may include one or more of the following features. Receiving the intent of instructions in a clearance message may comprise preprocessing a received clearance message (e.g., CPLDC or voice) to obtain segmented text; applying parts of speech (POS) tags to the segmented text; and identifying the intent of the instructions in the clearance message from the parts of speech (POS) tags. Determining a set of flight-crew executable instructions for performance to meet the intent of the instructions in the clearance message may comprise retrieving flight crew executable instructions from: a database containing one or more of standard operating procedures (SOPs), checklists, and/or an AFM (aircraft flight manual); or a task model that has been trained, based on past actions or preferences of the flight crew, to provide a set of flight-crew executable instructions for performance to meet the intent of the instructions in a clearance message. Causing the list of tasks along with the context sensitive elements to be displayed to the flight crew on a display device may comprise combining an event trigger with the task when performance of the task is conditioned on occurrence of an event. Causing the list of tasks along with the context sensitive elements to be displayed to the flight crew on a display device may comprise providing, when a task may be to occur at a predetermined time and the time to execute the task has occurred, a selectable link to be displayed to flight crew that may be configurable to cause, when selected, the execution of the task. Causing the list of tasks along with the context sensitive elements to be displayed to the flight crew on a display device may comprise causing a checklist and an element of interest associated with the checklist item to be displayed to the flight crew when the task may be a checklist item to be monitored. The method may further comprise comparing the task list with actual flight crew action and recording the actual flight crew action, context sensitive elements, and the intent of the instructions in the clearance message for use in deriving a set of flight-crew executable instructions for a similar, future clearance message. The method may further comprise training a model to learn to predict flight crew action based on the intent of the instructions in the clearance message and the context sensitive elements related to the tasks. Determining a set of flight-crew executable instructions for performance to meet the intent of the instructions in the clearance message may comprise predicting, using the trained model, a set of flight-crew executable instructions based on the intent of the instructions in the clearance message and the context sensitive elements related to the tasks.

In another embodiment, non-transitory computer readable media encoded with programming instructions configurable to cause a processor to perform a method is provided. The method comprises receiving the intent of instructions in a clearance message; determining a set of flight-crew executable instructions for performance to meet the intent of the instructions in the clearance message; grouping the set of instructions as a list of tasks; retrieving aircraft state information from one or more onboard avionics systems; determining context sensitive elements related to the tasks using the retrieved aircraft state information; adding the context sensitive elements to the list of tasks; and causing the list of tasks along with the context sensitive elements to be displayed to the flight crew on a display device.

These aspects and other embodiments may include one or more of the following features. Receiving the intent of instructions in a clearance message may comprise preprocessing a received clearance message (e.g., CPLDC or voice) to obtain segmented text; applying parts of speech (POS) tags to the segmented text; and identifying the intent of the instructions in the clearance message from the parts of speech (POS) tags. Determining a set of flight-crew executable instructions for performance to meet the intent of the instructions in the clearance message may comprise retrieving flight crew executable instructions from: a database containing one or more of standard operating procedures (SOPs), checklists, and/or an AFM (aircraft flight manual); or a task model that has been trained, based on past actions or preferences of the flight crew, to provide a set of flight-crew executable instructions for performance to meet the intent of the instructions in a clearance message. Causing the list of tasks along with the context sensitive elements to be displayed to the flight crew on a display device may comprise combining an event trigger with the task when performance of the task is conditioned on occurrence of an event. Causing the list of tasks along with the context sensitive elements to be displayed to the flight crew on a display device may comprise providing, when a task may be to occur at a predetermined time and the time to execute the task has occurred, a selectable link to be displayed to flight crew that may be configurable to cause, when selected, the execution of the task. Causing the list of tasks along with the context sensitive elements to be displayed to the flight crew on a display device may comprise causing a checklist and an element of interest associated with the checklist item to be displayed to the flight crew when the task may be a checklist item to be monitored. The method may further comprise comparing the task list with actual flight crew action and recording the actual flight crew action, context sensitive elements, and the intent of the instructions in the clearance message for use in deriving a set of flight-crew executable instructions for a similar, future clearance message. The method may further comprise training a model to learn to predict flight crew action based on the intent of the instructions in the clearance message and the context sensitive elements related to the tasks. Determining a set of flight-crew executable instructions for performance to meet the intent of the instructions in the clearance message may comprise predicting, using the trained model, a set of flight-crew executable instructions based on the intent of the instructions in the clearance message and the context sensitive elements related to the tasks.

In another embodiment, a flight deck system for converting a clearance message into sub-tasks for flight crew to execute is provided. The flight deck system comprises a controller configured to: preprocess a received clearance message (e.g., CPLDC or voice) to obtain segmented text; apply parts of speech (POS) tags to the segmented text; identify the intent of the instructions in the clearance message from the parts of speech (POS) tags; retrieve a set of flight-crew executable instructions relating to the intent of the instructions in the clearance message from a database containing standard operating procedures (SOPs), checklists, and/or an AFM (aircraft flight manual); group the set of instructions as a list of tasks; determine context sensitive elements related to the tasks; add the context sensitive elements to the list of tasks; associate the tasks and the context sensitive elements; and cause the list of tasks along with the context sensitive elements to be displayed to the flight crew on a display device, wherein to cause the list of tasks along with the context sensitive elements to be displayed to the flight crew on a display device the controller is further configured to: combine an event trigger with the task when performance of the task is conditioned on occurrence of an event; provide, when a task is to occur at a predetermined time and the time to execute the task has occurred, a selectable link to be displayed to flight crew that is configurable to cause, when selected, the execution of the task; and cause to display a checklist and an element of interest associated with the checklist item to the flight crew when the task is a checklist item to be monitored. The controller is further configured to compare the task list with actual flight crew action and record the actual flight crew action, context sensitive elements, and the intent of the instructions in the clearance message; and train a model to learn to predict flight crew action based on the intent of the instructions in the clearance message and context sensitive elements.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A flight deck system for converting a clearance message into sub-tasks for flight crew to execute, the flight deck system comprising a controller configured to:
receive the intent of instructions in a clearance message;
determine a set of flight-crew executable instructions for performance to meet the intent of the instructions in the clearance message;
group the set of instructions as a list of tasks;
retrieve aircraft state information from one or more onboard avionics systems;
determine context sensitive elements related to the set of instructions in the list of tasks using the retrieved aircraft state information;
add the context sensitive elements to the list of tasks; and
cause the list of tasks, which includes the set of instructions and the context sensitive elements, to be displayed for flight crew viewing on a display device.

2. The flight deck system according to claim 1, wherein to receive the intent of instructions in a clearance message the flight deck system is configured to:
preprocess a received clearance message to obtain segmented text;
apply parts of speech (POS) tags to the segmented text; and
identify the intent of the instructions in the clearance message from the parts of speech (POS) tags.

3. The flight deck system according to claim 1, wherein to determine a set of flight-crew executable instructions for performance to meet the intent of the instructions in the clearance message the controller is configured to retrieve flight crew executable instructions from:
a database containing one or more of standard operating procedures (SOPs), checklists, and/or an AFM (aircraft flight manual); or
a task model that has been trained, based on past actions or preferences of the flight crew, to provide a set of flight-crew executable instructions for performance to meet the intent of the instructions in a clearance message.

4. The flight deck system according to claim 1, wherein to cause the list of tasks along with the context sensitive elements to be displayed to the flight crew on a display device the controller is further configured to:
combine an event trigger with the task when performance of the task is conditioned on occurrence of an event.

5. The flight deck system according to claim 4, wherein to cause the list of tasks along with the context sensitive elements to be displayed to the flight crew on a display device the controller is further configured to:
provide, when a task is to occur at a predetermined time and the time to execute the task has occurred, a selectable link to be displayed to flight crew that is configurable to cause, when selected, the execution of the task.

6. The flight deck system according to claim 5, wherein to cause the list of tasks along with the context sensitive elements to be displayed to the flight crew on a display device the controller is further configured to:
cause to display a checklist and an element of interest associated with the checklist item to the flight crew when the task is a checklist item to be monitored.

7. The flight deck system according to claim 1, wherein the controller is further configured to:
compare the task list with actual flight crew action and record the actual flight crew action, context sensitive elements, and the intent of the instructions in the clearance message for use in deriving a set of flight-crew executable instructions for a similar, future clearance message.

8. The flight deck system according to claim 7, wherein the controller is further configured to:
train a model to learn to predict flight crew action based on the intent of the instructions in the clearance message and the context sensitive elements related to the tasks.

9. The flight deck system according to claim 8, wherein to determine a set of flight-crew executable instructions for performance to meet the intent of the instructions in the clearance message the controller is configured to:
predict, using the trained model, a set of flight-crew executable instructions based on the intent of the instructions in the clearance message and the context sensitive elements related to the tasks.

10. A method in a flight deck system for converting a clearance message into sub-tasks for flight crew to execute, the method comprising:
receiving the intent of instructions in a clearance message;
determining a set of flight-crew executable instructions for performance to meet the intent of the instructions in the clearance message;
grouping the set of instructions as a list of tasks;
retrieving aircraft state information from one or more onboard avionics systems;
determining context sensitive elements related to the tasks using the retrieved aircraft state information;
adding the context sensitive elements to the list of tasks; and
causing the list of tasks along with the context sensitive elements to be displayed to the flight crew on a display device.

11. The method of claim 10, wherein receiving the intent of instructions in a clearance message comprises:
preprocessing a received clearance message to obtain segmented text;
applying parts of speech (POS) tags to the segmented text; and
identifying the intent of the instructions in the clearance message from the parts of speech (POS) tags.

12. The method of claim 10, wherein determining a set of flight-crew executable instructions for performance to meet the intent of the instructions in the clearance message comprises retrieving flight crew executable instructions from:
a database containing one or more of standard operating procedures (SOPs), checklists, and/or an AFM (aircraft flight manual); or
a task model that has been trained, based on past actions or preferences of the flight crew, to provide a set of flight-crew executable instructions for performance to meet the intent of the instructions in a clearance message.

13. The method of claim 10, wherein causing the list of tasks along with the context sensitive elements to be displayed to the flight crew on a display device comprises combining an event trigger with the task when performance of the task is conditioned on occurrence of an event.

14. The method of claim 13, wherein causing the list of tasks along with the context sensitive elements to be displayed to the flight crew on a display device comprises providing, when a task is to occur at a predetermined time and the time to execute the task has occurred, a selectable link to be displayed to flight crew that is configurable to cause, when selected, the execution of the task.

15. The method of claim 14, wherein causing the list of tasks along with the context sensitive elements to be displayed to the flight crew on a display device comprises causing a checklist and an element of interest associated with the checklist item to be displayed to the flight crew when the task is a checklist item to be monitored.

16. The method of claim 1, further comprising comparing the task list with actual flight crew action and recording the actual flight crew action, context sensitive elements, and the intent of the instructions in the clearance message for use in deriving a set of flight-crew executable instructions for a similar, future clearance message.

17. The method of claim 16, further comprising training a model to learn to predict flight crew action based on the intent of the instructions in the clearance message and the context sensitive elements related to the tasks.

18. The method of claim 17, wherein determining a set of flight-crew executable instructions for performance to meet the intent of the instructions in the clearance message comprises predicting, using the trained model, a set of flight-crew executable instructions based on the intent of the instructions in the clearance message and the context sensitive elements related to the tasks.

19. Non-transitory computer readable media encoded with programming instructions configurable to cause a processor to perform a method, the method comprising:
receiving the intent of instructions in a clearance message;
determining a set of flight-crew executable instructions for performance to meet the intent of the instructions in the clearance message;
grouping the set of instructions as a list of tasks;
retrieving aircraft state information from one or more onboard avionics systems;
determining context sensitive elements related to the tasks using the retrieved aircraft state information;
adding the context sensitive elements to the list of tasks; and
causing the list of tasks along with the context sensitive elements to be displayed to the flight crew on a display device.

20. The non-transitory computer readable media of claim 19, wherein causing the list of tasks along with the context sensitive elements to be displayed to the flight crew on a display device comprises:
combining an event trigger with the task when performance of the task is conditioned on occurrence of an event;
providing, when a task is to occur at a predetermined time and the time to execute the task has occurred, a selectable link to be displayed to flight crew that is configurable to cause, when selected, the execution of the task; and
causing to display a checklist and an element of interest associated with the checklist item to the flight crew when the task is a checklist item to be monitored.
